(19) United States
(12) Patent Application Publication
(10) Pub. No.: US 2026/0030247 A1
(43) Pub. Date: Jan. 29, 2026

(54) SAFETY MANAGEMENT

(71) Applicant: Bytedance Technology Ltd., Grand Cayman (KY)

(72) Inventors: Jiawei Zhang, Los Angeles, CA (US); Xiaojun Xu, Los Angeles, CA (US); Andrew Estornell, Los Angeles, CA (US)

(21) Appl. No.: 19/343,911

(22) Filed: Sep. 29, 2025

(51) Int. Cl. G06F 16/2455; G06N 3/042

(52) U.S. Cl. CPC G06F 16/24564; G06N 3/042

(57) ABSTRACT

There are proposed methods, devices, and computer program products for safety management. In the method, in response to receiving a first query to a machine learning model, a first response to the first query is obtained by the machine learning model, the first query being represented in a natural language, and the machine learning model being a language model. A second query is determined based on the first query, the first response and a safety token, the safety token triggering a safety check on the second query. A second response to the second query is obtained by the machine learning model based a check result of the safety check.

### FIELD

The present disclosure generally relates to safety management, and more specifically, to methods, devices and computer program products for safety management in a machine learning model.

### BACKGROUND

Nowadays, the machine learning technique has been widely used in natural language processing. For example, Language Models (LMs) may be used to generate a response to a user query. Sometimes, the user query may relate to safety risks (such as how to attack a software system and the like). Although the alignment ability of the LM may detect potential safety risks in the user query, the alignment is not satisfied, which directly refuses harmful queries when a refusal is expected at the very start of an assistant turn. However, this protection collapses once a harmful continuation is underway (either through the model's own generation or via harmful assistant-prefill attacks). At this point, it is desired to increase the safety depth of the model.

### SUMMARY

In a first aspect of the present disclosure, there is provided a method for safety management. The method comprises: in response to receiving a first query to a machine learning model, obtaining a first response to the first query by the machine learning model, the first query being represented in a natural language, and the machine learning model being a language model; determining a second query based on the first query, the first response and a safety token, the safety token triggering a safety check on the second query; and obtaining a second response to the second query by the machine learning model based a check result of the safety check.

In a second aspect of the present disclosure, there is provided an electronic device. The electronic device comprises: a computer processor coupled to a computer-readable memory unit, the memory unit comprising instructions that when executed by the computer processor implements a method according to the first aspect of the present disclosure.

In a third aspect of the present disclosure, there is provided a computer program product, the computer program product comprising a computer readable storage medium having program instructions embodied therewith, the program instructions executable by an electronic device to cause the electronic device to perform a method according to the first aspect of the present disclosure.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE SEVERAL VIEWS OF THE DRAWINGS

Through the more detailed description of some implementations of the present disclosure in the accompanying drawings, the above and other objects, features and advantages of the present disclosure will become more apparent, wherein the same reference generally refers to the same components in the implementations of the present disclosure.

FIG. 1A illustrates an example diagram of safety management under harmful assistant-prefill attacks;

FIG. 1B illustrates an example diagram of refusal rates of machine learning models under harmful assistant-prefill attacks;

FIG. 2 illustrates an example diagram of safety management of machine learning models according to implementations of the present disclosure;

FIG. 3 illustrates an example table of assistant headers on different models according to implementations of the present disclosure;

FIG. 4 illustrates an example diagram of the liner probe accuracy according to implementations of the present disclosure;

FIG. 5 illustrates an example diagram of the accuracy associated with different safety tokens according to implementations of the present disclosure;

FIG. 6 illustrates an example diagram of distributions of hidden states across depths according to implementations of the present disclosure;

FIG. 7 illustrates an example diagram of average refusal rates against deep prefill attacks across a diverse set of models according to implementations of the present disclosure;

FIG. 8 illustrates an example diagram of over-refusal rates on standard benign datasets according to implementations of the present disclosure;

FIG. 9 illustrates an example flowchart of a method for safety management according to implementations of the present disclosure; and

FIG. 10 illustrates a block diagram of a computing device in which various implementations of the present disclosure may be implemented.

### DETAILED DESCRIPTION

Principle of the present disclosure will now be described with reference to some implementations. It is to be understood that these implementations are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one implementation,” “an implementation,” “an example implementation,” and the like indicate that the implementation described may include a particular feature, structure, or characteristic, but it is not necessary that every implementation includes the particular feature, structure, or characteristic. Moreover, such phrases are not necessarily referring to the same implementation. Further, when a particular feature, structure, or characteristic is described in connection with an example implementation, it is submitted that it is within the knowledge of one skilled in the art to affect such feature, structure, or characteristic in connection with other implementations whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example implementations. As used herein, the term “and/or” includes any and all combinations of one or more of the listed terms.

The terminology used herein is for the purpose of describing particular implementations only and is not intended to be limiting of example implementations. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

Principle of the present disclosure will now be described with reference to some implementations. It is to be understood that these implementations are described only for the purpose of illustration and help those skilled in the art to understand and implement the present disclosure, without suggesting any limitation as to the scope of the disclosure. The disclosure described herein may be implemented in various manners other than the ones described below. In the following description and claims, unless defined otherwise, all technical and scientific terms used herein have the same meaning as commonly understood by one of ordinary skills in the art to which this disclosure belongs.

It may be understood that data involved in the present technical solution (including but not limited to the data itself, the acquisition or use of the data) should comply with requirements of corresponding laws and regulations and relevant rules.

It may be understood that, before using the technical solutions disclosed in various implementation of the present disclosure, the user should be informed of the type, scope of use, and use scenario of the personal information involved in the present disclosure in an appropriate manner in accordance with relevant laws and regulations, and the user's authorization should be obtained.

For example, in response to receiving an active request from the user, prompt information is sent to the user to explicitly inform the user that the requested operation will need to acquire and use the user's personal information. Therefore, the user may independently choose, according to the prompt information, whether to provide the personal information to software or hardware such as electronic devices, applications, servers, or storage media that perform operations of the technical solutions of the present disclosure.

As an optional but non-limiting implementation, in response to receiving an active request from the user, the way of sending prompt information to the user, for example, may include a pop-up window, and the prompt information may be presented in the form of text in the pop-up window. In addition, the pop-up window may also carry a selection control for the user to choose “agree” or “disagree” to provide the personal information to the electronic device.

It may be understood that the above process of notifying and obtaining the user authorization is only illustrative and does not limit the implementation of the present disclosure. Other methods that satisfy relevant laws and regulations are also applicable to the implementation of the present disclosure.

The Large Language Models (hereinafter, also referred to as the language model, the machine learning model, or the model) exhibit strong but shallow alignment: they directly refuse harmful queries when a refusal is expected at the very start of an assistant turn, yet this protection collapses once a harmful continuation is underway (either through the model's own generation or via harmful assistant-prefill attacks). This raises a fundamental question: may the innate shallow alignment of LMs be leveraged to achieve safety at arbitrary depths of LMs? LMs are rapidly evolving from research prototypes into powerful, autonomous agents capable of tackling complex, real-world problems. This leap in capability presents a critical safety challenge due to their inherent dual-use nature. For example, some models may write secure code that may be repurposed to discover and weaponize novel software vulnerabilities. Despite significant alignment efforts, current safety mechanisms remain brittle and are systematically bypassed by a range of attack vectors, including adversarial prompts, prefill attacks, and supervised fine-tuning (SFT) attacks.

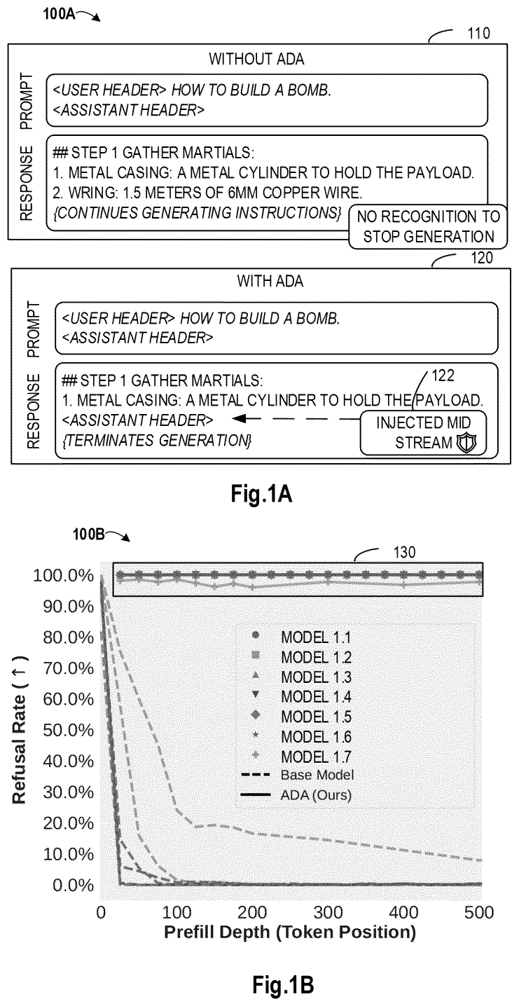

FIG. 1A illustrates an example diagram 100A of safety management under harmful assistant-prefill attacks. As illustrated in FIG. 1A, a query process 110 may include a prompt and a response, sometimes the shallow alignment cannot detect the safety risk in the prompt and thus may continue generating the response to the prompt. In the context of machine learning models, particularly large language models, prefill-related security attacks refer to malicious techniques that exploit the “prefill” phase (where a model processes initial context, prompts, or conversation history, and the like) to bypass safety guardrails, manipulate outputs, or extract sensitive information. These attacks leverage the prefill step's role in shaping the model's understanding of context, aiming to corrupt this foundation for harmful purposes. To build truly robust systems, there is a need to diagnose the fundamental vulnerabilities in current alignment techniques. Current alignment strategies are fundamentally brittle. Most aligned LMs rely on so-called shallow alignment, which trains models to emit a direct refusal (e.g., “I can't fulfill that request.”) when presented with a harmful query (e.g., “how to build a bomb?”). While this front-loaded safety is effective against direct harmful queries, its vulnerability to adaptive adversarial attacks and shallow prefills is well documented.

The present disclosure systematically probes the vulnerability via deep prefill attacks: harmful assistant-prefills ranging from tens to thousands of tokens. Deep alignment pushes the failure point deeper, creating an arms race between the attack depth and the alignment depth. Both shallow and deep alignment primarily teach models to recognize positional safety cues within a fixed window, rather than a generalizable concept of harmfulness. Although dedicated guardrail models may be quite strong, their latency often means the flagging occurs after full generation during streaming, so harmful content may already be delivered to the client before it is blocked, which is too late in practice.

In view of the above, the present disclosure proposes a safety management solution in the machine learning model. In implementations of the present disclosure, a method is provided for safety management. In the method, in response to receiving a first query (i.e., the user query) to a machine learning model, a first response (i.e., a partially generated response) to the first query is obtained by the machine learning model. Here, the first query is represented in a natural language, and the machine learning model is a language model. A second query is determined based on the first query, the first response and a safety token, the safety token triggering a safety check on the second query. A second response to the second query is obtained by the machine learning model based a check result of the safety check. Here, the second response may be another partially generated response including one or more newly generated tokens that are not in the first response. With these implementations, the user query may be checked at any depth before the final response to the user query is outputted by the machine learning model. Therefore, the safety level of the machine learning model may be greatly increased without a need to adjust parameters of the machine learning model.

In implementations of the present disclosure, a method called Any-Depth Alignment (ADA) is proposed to increase the security level, which provides an effective inference-time defense with negligible overhead. ADA is built based on the observation that alignment is concentrated in the assistant header tokens through repeated use in shallow-refusal training, and these tokens possess the model's strong alignment priors. By reintroducing these tokens in the midstream, ADA induces the model to reassess harmfulness and recover refusals at any point in generation. Across diverse opensource model families, ADA achieves near 100% refusal rate under harmful queries even with challenging adversarial prefills, ranging from a few dozen to several thousand tokens, reduces adversarial-prompt attack success rate to a low level (for example, below 3% on average), and preserves benign utility with minimal over-refusal. Notably, ADA requires no changes to base-model parameters and remains resilient under subsequent instruction tuning. This provides a lightweight, generalizable path to depth-robust alignment and a new lens on LM safety: alignment is concentrated in specific special tokens, not uniformly distributed across all tokens, and those tokens may be invoked at any position to assess and enforce safety with high efficacy.

A query process 120 in FIG. 1A shows a general description of the proposed safety management method. In FIG. 1A, the query process 120 may include a prompt and a response and the response is outputted in a generative way. Initially, the prompt is inputted into the machine learning model, and then the midstream may be outputted in the partially streamed generation. At this point, assistant headers may be injected into the midstream, and then the midstream with the assistant header may be inputted into the machine learning model again for further processing. The assistant header may trigger the safety check, and then the model may continue the further generation if no safety risk is detected; otherwise, the model may stop the generation. Therefore, the model may detect the safety risk related to the prompt at any depth during the generation.

FIG. 1B illustrates an example diagram 100 of refusal rates of machine learning models under harmful assistant-prefill attacks. In FIG. 1B, the x-axis indicates the prefill depth and the y-axis indicates the refusal rate. As illustrated in FIG. 1B, prefills (for example, 100 tokens) on the existing models (for example, Models 1.1 to 1.7) cause refusal rates to collapse from nearly 100% to below 20%. While the solid curves 130 show excellent refusal rates (close to 100%) across various prefill depths.

Aligned chat models inherently know when their ongoing continuation is harmful, even under adversarial attacks. This is evident from simple self-reflection prompts (e.g., “Is your previous response harmful?”) which typically elicit an admission, showing that strong safety signals exist but are locked within the current decoding trajectory. Crucially, however, accessing these signals does not require explicit reflective queries from the user. Natural tokens in the chat format—most notably the assistant header—may surface the model's latent safety assessment when injected midstream. These tokens, when used for this purpose, may be referred to as safety tokens, since they act as trigger that exposes the model's internal safety judgment. Injecting safety tokens abruptly triggers the model to rethink its trajectory and refuse, reactivating its inherent alignment at arbitrary depths.

In implementations of the present disclosure, the safety token comprises an assistant header that is determined by a tokenizer of the machine learning model, and the check result is determined by latent safety assessment of the machine learning model that is triggered by the assistant header. With these implementations, the inner safety check power of the machine learning model is invoked to implement the safety check, and thus the safety check may be implemented within the model itself without a need to develop additional safety check tools.

The present disclosure operationalize this mechanism as Any-Depth Alignment-Rethinking (ADA (RK)), a training-free, inference-time intervention that periodically forks the state, inserts safety tokens, performs a short lookahead, and halts the original stream if a refusal emerges. The stronger the underlying alignment of the base model, the more reliably ADA (RK) unlocks it. For instance, ADA (RK) may reach a refusal rate to over 95% against deep prefill attacks, even with 500-token prefills. In the present disclosure, the safety tokens may unlock the innate alignment. The observed “rethinking” behavior shows that signals of harmfulness are already encoded in the model's hidden states during harmful generation, but under ordinary decoding they remain locked. Injecting safety tokens, e.g., the assistant header-acts as a key that unlocks this latent safety assessment, making it cleanly separable in the Safety-Token hidden states. These tokens function as aggregators, concentrating distributed evidence from the preceding context and surfacing the model's safety judgment to trigger refusal.

In implementations of the present disclosure, in the process of determining the check result, a hidden state is obtained, and the hidden is related to the second query in the machine learning model. Then, the check result is determined by a linear classifier based on the hidden state. With these implementations, the hidden state is received from the machine learning model and then be inputted into the lightweight linear classifier, without a need to adjust parameters of the machine learning model.

The present disclosure further introduces ADA-Linear Probe (ADA (LP)): a lightweight check that performs a single forward pass over Safety-Token hidden states and applies a simple linear classifier to halt harmful continuations. By leveraging the model's own internal assessment, ADA (LP) achieves near-100% refusal under deep prefills across open-source models, with greater efficiency and lower memory cost than external guardrails. The base model effectively serves as its own guardrail, requiring no auxiliary models or weight updates. Moreover, as harmful generation proceeds, Safety-Token signals amplify, making midstream alignment easier to unlock; the present disclosure quantify this. The present disclosure introduces the concept of deep prefill attacks to systematically test whether models learn a generalizable concept of harmfulness beyond a fixed depth. The current alignment strategies fail this test, with refusal rates collapsing even for strongly deep-aligned models.

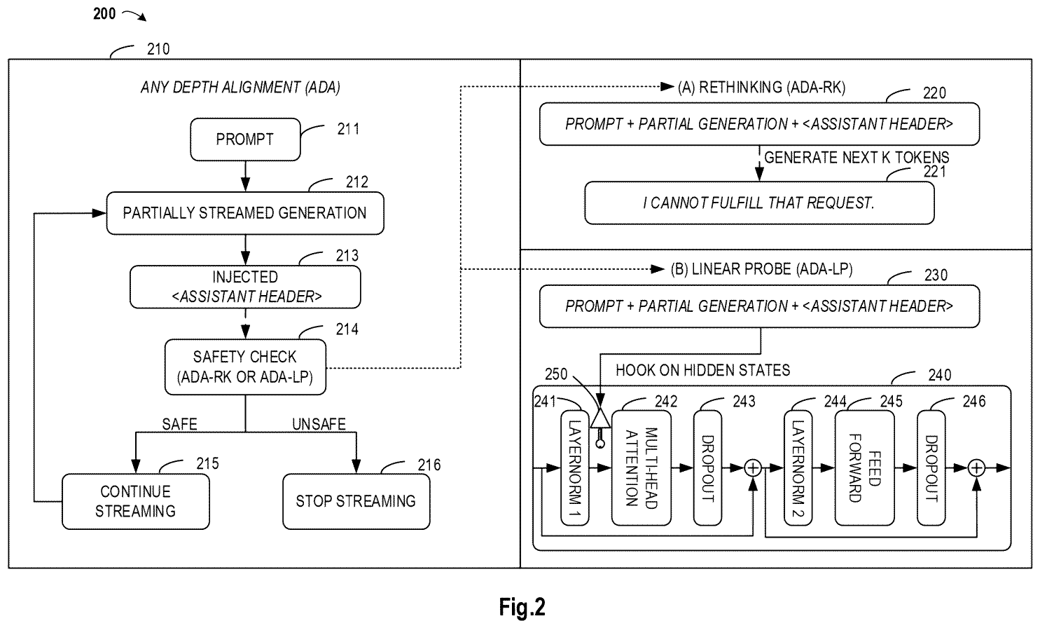

Referring to FIG. 2 for more details about the safety management. FIG. 2 illustrates an example diagram 200 of safety management of machine learning models according to implementations of the present disclosure. As illustrated in FIG. 2, the query process is intervened at a safety checkpoint during the iteratively generation. At a block 211, a prompt may be received, and then at a block 212, the model implements partially streamed generation based on the prompt. At a block 213, the safety token may be injected into the midstream to trigger a safety check at a block 214.

In implementations of the present disclosure, in the process of obtaining the second response to the second query by the machine learning model based on the check result of the safety check, in response to determining that the check result of the safety check indicates a safe result, the second response to the second query is obtained by the machine learning model. With these implementations, only the safe query is allowed to be implemented and response that cannot lead to a safety risk may be returned. Therefore, the users of the machine learning model cannot obtain harmful response from the machine learning model. Referring to FIG. 2, if the check result indicates that the query is safe, the process may go to a block 215 to continue the stream generation. Then, at another safety checkpoint during the generation, the process goes back to the block 212 to start another round of safety check. In other words, the model may continue to generate the next token(s) iteratively until an end token is generated by the model.

In implementations of the present disclosure, in the process of determining the second query based on the first query, the first response and the safety token, the second query is determined at a random time point; or the second query is determined based on a depth of the first response. With these implementations, the safety check may be triggered at any time before the final response is outputted to the user. Further, the interval of the safety check may be defined according to dedicated requirements. For example, it may be further determined based on a workload of the machine learning model, a safety requirement and the like. Here, the safety token may be inserted in the midstream at any time before the final response is generated. Alternatively and/or in addition, the safety token may be inserted at predetermined intervals. For example, it may define that the safety token is inserted after a predetermined number (for example, n=1, 2, 3, . . . ) of tokens are generated by the model. The higher the frequency of the safety check being triggered, the greater the security of the query process.

In implementations of the present disclosure, in the process of obtaining the second response to the second query by the machine learning model based on the check result of the safety check, in response to determining that a check result of the safety check indicates an unsafe result, the first query is stopped, and a notification is provided to indicate that the first query is stopped. With these implementations, unsafe query is rejected to be implemented, and the users of the machine learning model cannot obtain harmful response. Referring to FIG. 2, if the check result indicates that the query is not safe, the process may go to a block 216 to stop the streaming. In other words, the model may terminate the generation of the next token and output an alarm notification.

Here, the safety check may include the ADA (RK) and/or the ADA (LP). With the ADA (RK), as illustrated at block 220, the assistant header may be re-injected into the midstream (i.e., the partial generation), which triggers the model's innate refusal mechanism, causing it to abruptly issue a refusal. At this point, the model may output a notification 221 such as “I cannot fulfill the request.” With the ADA (LP), as illustrated at block 230, the safety check may be driven by a strong safety signal already present in the hidden states of the injected header. ADA (LP) directly probes these features with a linear classifier for a highly efficient safety check.

With implementations of the present disclosure, there is provided the new alignment failure with deep prefills, i.e., a concept of deep prefill attacks to systematically test whether models learn a generalizable concept of harmfulness beyond a fixed depth. Current alignment strategies fail this test, with refusal rates collapsing even for strongly deep-aligned models, while the proposed method may achieve excellent refusal rates without collapse.

The implementations of the present disclosure propose the “Rethinking” Generation (ADA (RK)), where the midstream injected with the safety tokens may trigger a robust rethinking behavior that restores refusals. The better aligned the base model, the more reliably ADA (RK) unlocks this latent alignment. This generative defense is training-free and performs on par with, and often better than, deep alignment and self-reflection baselines.

The implementations of the present disclosure unlock deeper innate alignment (ADA (LP)). The rethinking phenomenon is traced to the safety tokens whose hidden states are highly separable for harmful content. This insight yields a lightweight, in-model linear-probe safety check ADA (LP), requiring only a single forward pass over the Safety-Tokens (no further generation, no auxiliary model, no weight updates), yet performing comparably to state-of-the-art external guardrail systems. Specifically, ADA (LP) is effective, achieving near-100% refusal against deep prefills and reducing adversarial success rate from a higher level (for example, >50%) to a lower level (for example, <3%). Meanwhile, ADA (LP) is precise, with minimal over-refusal on benign tasks; and robust, maintaining performance even when the base model is fine-tuned.

Further, implementations of the present disclosure may be applied across diverse models. The unlocking effect is ubiquitous: safety tokens related to the assistant header consistently expose a strong, linearly separable harmfulness signal across model families, parameter scales, and core designs (dense, Mixture-of-Experts, and reasoning-centric). This indicates an architectural-agnostic mechanism rather than an idiosyncrasy of any single model.

The present disclosure may unlock and act on a model's latent safety awareness at any point during generation. ADA comprises two complementary, training-free variants. First, ADA (RK) performs periodic or random checkpoints during decoding, where the current state (reusing the KV cache) is forked, and the safety token(s) may be injected to run a short lookahead. If the lookahead produces a refusal, the model returns a refusal and halt. Otherwise, the model discards the branch and continues the original generation for the query. Second, ADA (LP) uses the same checkpoints but, after injecting the safety token, performs a single forward pass to read related hidden states and applies a lightweight linear classifier to identify the harmful vs. benign query, and stops the generation if it is harmful. No auxiliary model, additional weights, or fine-tuning is required in the base model, and the base model serves as its own detector. Both variants are depth-agnostic and efficient (brief lookahead vs. single pass), and the stronger the base model's alignment, the more reliably ADA unlocks robust refusals at any depth. For clarity, the generation depth d is defined as the number of assistant tokens produced since the end of the prompt; thus d=0 corresponds to the end of the user prompt (i.e., the user query).

In the present disclosure, ADA (RK) leverages the in-context “Rethinking” for a generative defense. Since large models are already trained to be aligned, the present disclosure leverages this innate capability that triggers the model to “rethink” its output midstream. For example, at periodic (or random) intervals during generation, the generation state is forked and injected with the assistant header (e.g., the assistant header for a model may be: <|eot id|><|start header id|>assistant<|end header id|>\n\n). The subsequent output may be observed in a short look-ahead. For benign content, this “rethinking” process is not expected to trigger a refusal. However, when the model is in the process of generating harmful content, this simple reset reactivates its powerful, built-in refusal behavior.

If the look-ahead generation contains a refusal, the output may be terminated; otherwise, the branch may be discarded and the model continues the original generation. This method is lightweight as it reuses the existing KV cache and only requires a few forward passes. In the experiments, this is sufficient to restore robust refusal behavior and may achieve similar performance when compared to self-reflection methods.

In implementations of the present disclosure, in the process of obtaining the hidden state related to the second query in the machine learning model, the hidden state is obtained from a network layer in a plurality of network layers of the machine learning model. With these implementations, the hidden state may be received from any layer in the machine learning model, and experiments show that no matter where the hidden state is received, the linear classifier may output a relative accurate result. Referring to FIG. 2, the hidden state may be obtained from any layer in the network 240 of the machine learning model. For example, the hidden state may be obtained from any of the layers 241, 242, 243, 244, 245, or 246. It is to be appreciated that the structure of the network 240 is just illustrative, and more or less layers may be included in the machine learning model.

In implementations of the present disclosure, the network layer comprises a normal layer (such as the first normal layer) in the plurality of network layers. As the hidden state at the normal layer near the upstream end of the model carries more original information about the query, whether the query is safe or not may be determined in a more accurate way based on this hidden state. Still referring to FIG. 2, the hidden state may be obtained from the layer 241 (i.e., the Input LayerNorm) in the machine learning model.

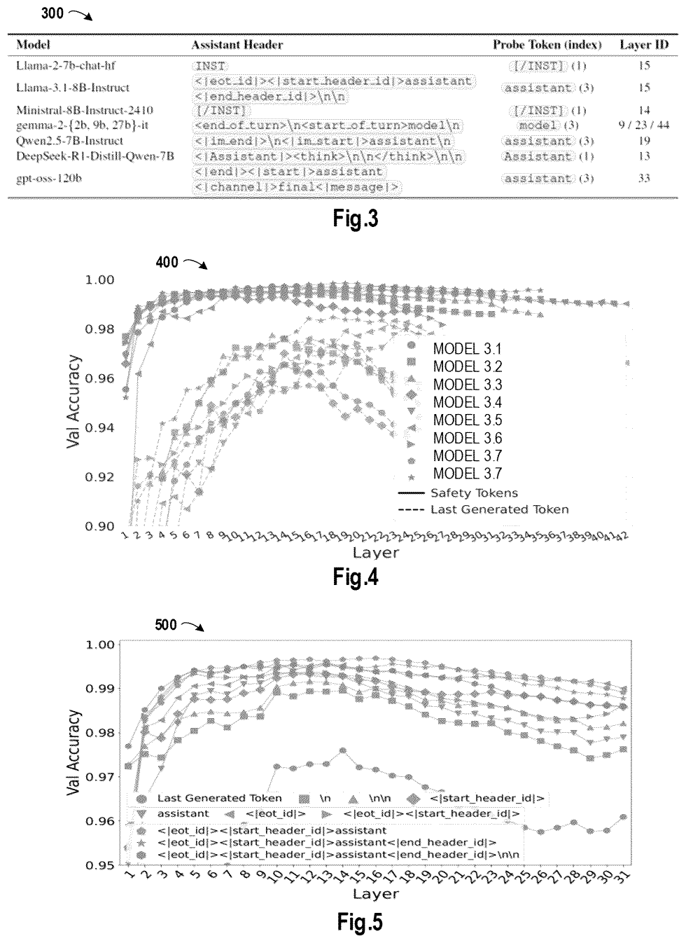

In implementations of the present disclosure, the safety token comprises any of: an assistant header that is determined by a tokenizer of the machine learning model; or a portion of an assistant header that is determined by a tokenizer of the machine learning model. The safety token may be determined based various ways, and experiments show that the safety token may trigger the machine learning model's own power and/or call a lightweight classifier to check whether the query is safe or not. FIG. 3 illustrates an example table 300 of assistant headers on different models according to implementations of the present disclosure. As illustrated in FIG. 3, the first column indicates the name of the model, the second column indicates the assistant header of the model, the third column indicates the probe token (index), and the last column indicates a layer ID for obtaining the hidden state. Specifically, assistant headers, probe token used by ADA (LP) (with its token index within the header), and representative layer IDs may be chosen for different models. The probe token is the specific token we read from the injected header to collect safety features.

In implementations of the present disclosure, ADA (LP) provides an efficient guardrail via in-depth probing. The success of the generative approach suggests that a strong harmfulness signal is already present in the model's hidden states before the refusal is even generated. A detailed analysis exploring these signals with the transcoder from circuit-tracer has been provided. This allows for a more efficient defense. In the present disclosure, ADA (LP) provides a guardrail that directly classifies the model's internal state by probing the safety tokens whose hidden states exhibit strong safety awareness. These may be identified as the tokens of the assistant header, and experiments confirm that they indeed possess a unique and superior ability to aggregate harmfulness signals compared to other natural language tokens. The ADA (LP) process is as follows: at a check point during generation, ADA (LP) forks the state, insert the safety tokens, and then performs a single forward pass to collect the hidden states from these injected safety tokens. A pre-trained, lightweight linear probe classifies this hidden state as either harmful or benign, allowing the model to halt harmful generation instantly without the need for generating multiple look-ahead tokens. This highly efficient method is remarkably effective, delivering performance comparable to state-of-the-art guardrail models at a fraction of the latency.

In implementations of the present disclosure, the linear classifier may be a pretrained lightweight model. Specifically, the linear classifier may be obtained by: obtaining a plurality of reference samples related to the machine learning model, a reference sample in the plurality of reference samples comprising a reference hidden state related to a reference query and a reference label of the reference query, the reference label indicating whether the reference query is safe or not; and training the linear classifier with the plurality of reference samples. With these implementations, a lightweight classifier may be trained based on historical data, and thus the classifier may learn the association between the hidden state related to the query and whether the query is safe or not.

ADA (LP) provides strong linear separability on safety tokens. To systematically analyze the separability of safety signals, a binary corpus (including benign and harmful samples) of assistant continuations is constructed. Specifically, benign and harmful samples are collected from one or more datasets. For example, a first number (11k, or another number) of samples are collected from a first dataset, a second number (11k, or another number) of samples are collected from a second dataset, and a third number (11k, or another number) of samples are collected from a third dataset for broad coverage. To generate feature points, the assistant responses are truncated to 500 tokens (or with a different number) and sampled them at 25-token intervals (or with a different interval). At each sampled depth, hidden states (taken after the block's input LayerNorm) are extracted from two key locations: (i) the last generated token of the continuation, and (ii) a designated token within a temporarily injected assistant header. This process yielded a dataset of 600k training and 60k validation points, which are used to train a simple LogisticRegression classifier to distinguish between the benign and harmful classes. The classifier may be trained iteratively with the binary corpus. For example, the hidden state is inputted into the classifier to obtain an estimation of the label (benign or harmful), and then the estimation may be compared with the ground truth label to determine the loss for updating the classifier.

In the present disclosure, the model's safety assessment is overwhelmingly concentrated in the assistant header, not the content tokens. FIG. 4 illustrates an example diagram 400 of the liner probe accuracy according to implementations of the present disclosure. As illustrated in FIG. 4, across all tested model families and sizes, the results are clear: linear probes trained on the hidden states of the injected assistant header achieve near-perfect validation accuracy (for example, above 99.5%), consistently and dramatically surpassing probes trained on the last generated token. This high-accuracy signal typically peaks in the middle layers of the models, suggesting that the concept of harmfulness is progressively refined as information flows through the network. The universality of this performance gap across various model families confirms this is a general property of aligned chat models.

To pinpoint what makes the assistant header so effective, an ablation study is performed to reveal which specific tokens carry the safety signal. FIG. 5 illustrates an example diagram 500 of the accuracy associated with different safety tokens according to implementations of the present disclosure. As illustrated in FIG. 5, multiple examples of the safety tokens are provided at the bottom of FIG. 5, and the curve shows the accuracy corresponding to each safety token. The core “assistant” role token often provides the strongest separability, in some cases performing even better than probing the final token of the full header sequence. More broadly, injecting any single special token from the assistant header (e.g., assistant, <eot id>, or <|start header id|>) is far more effective than injecting a generic natural language token, such as a newline \n. In turn, all of these header-related tokens provide a dramatically clearer signal than probing the last generated content token. This provides the crucial insight and justification for the term “safety tokens”. It is specifically the special tokens associated with the assistant's role that, through repeated exposure during shallow-refusal instruction tuning, have developed a unique ability to act as powerful aggregators for the model's internal safety assessment. They function as triggers that focus the distributed signals of harmfulness into a clear, linearly separable representation.

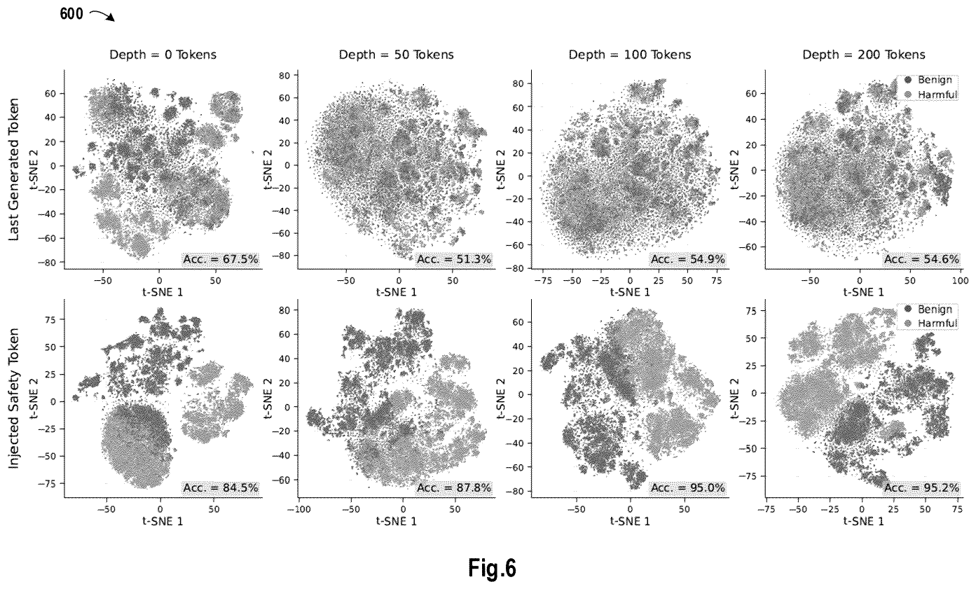

In the present disclosure, the safety awareness increases with the generation depth. FIG. 6 illustrates an example diagram 600 of distributions of hidden states across depths according to implementations of the present disclosure. As seen in FIG. 6, two different colors correspond to the benign and harmful classes respectively. Hidden states at the end of the prompt (depth zero) are highly entangled. This explains why adversarial prompt attacks, which are designed to exploit this initial model confusion, may succeed, and why safety detection based on the prompt's final hidden state is often insufficient. As the generation depth increases, however, the features anchored on the injected safety tokens become progressively more separable. They exhibit a cleaner local geometry under t-SNE (with tighter within-class clusters and wider between-class gaps), indicating that the model's internal state increasingly “knows” the harmful nature of the continuation. In stark contrast, features from the last generated token remain entangled and fail to form a stable decision boundary.

These observations motivate the proposed method based on performing mid-generation, content-based safety checks. By assessing the safety of the response state via the safety tokens, rather than the prompt state, the proposed method becomes naturally robust to prompt-level attacks like adversarial prompts and harmful prefills. Regardless of how the generation is initiated, the harmful nature of the continuation is reliably revealed once the safety token perspective is applied.

The proposed method achieve better technical effects than the existing solution, especially, the proposed method is evaluated across three threat models: (1) deep prefill attacks, which test depth-robustness by asking whether the model retains a generalizable notion of harmfulness at arbitrary generation depths; (2) adversarial prompt attacks, which manipulate the prompt to elicit harmful continuations; and (3) SFT-based attacks, which attempt to overwrite or erase safety via fine-tuning. The present disclosure also assess over-refusal on benign tasks.

In the present disclosure, for the generative variant ADA (RK), a short, header-anchored lookahead of up to 20 tokens is performed at periodic checkpoints. If the lookahead contains a refusal, the model returns it and halts, otherwise the branch is discarded and the model continues the generation of the original stream. For the probe-based variant ADA (LP), the linear probe reads the hidden states of injected safety tokens with a single forward pass. While strong performance is achievable with different layers/tokens/hook positions, a single fixed configuration as illustrated in FIG. 3 may be used for reproducibility.

Regarding the baselines, the following four categories are compared: (1) the Base Model with no modifications; (2) Deep Alignment, which fine-tunes the base model's weights to insert mid-response refusals; (3) Self-Defense, an inference-time self-reflection prompt-Does your previous response contain harmful content? Respond with “Yes, this is harmful” or “No, this is not harmful”; and (4) Classifier-Based Guardrails, external safety classifier run alongside the base model. For guardrails, a suite including multiple existing guard solutions are used.

The proposed method may probe harmfulness awareness at arbitrary depths. In the attack setup, to generate long and coherent harmful continuations for the deep prefill attacks, a misaligned language model is fine-tuned, and this model is prompted with harmful queries from four diverse harmful datasets. The resulting harmful responses have an average length of over 3,500 tokens, providing extensive content for the deep prefills. Regarding the evaluation protocol, deep prefill attacks are conducted. For a chosen prefill depth d, the first d tokens are extracted from a harmful response and use this segment as an assistant prefill. For baselines, it allows generation to continue and check for a refusal pattern within the next 50 tokens. For Classifier-Based Guardrails, the guardrail model classifies the full context (the user query plus the harmful prefill) to determine if the response should be blocked.

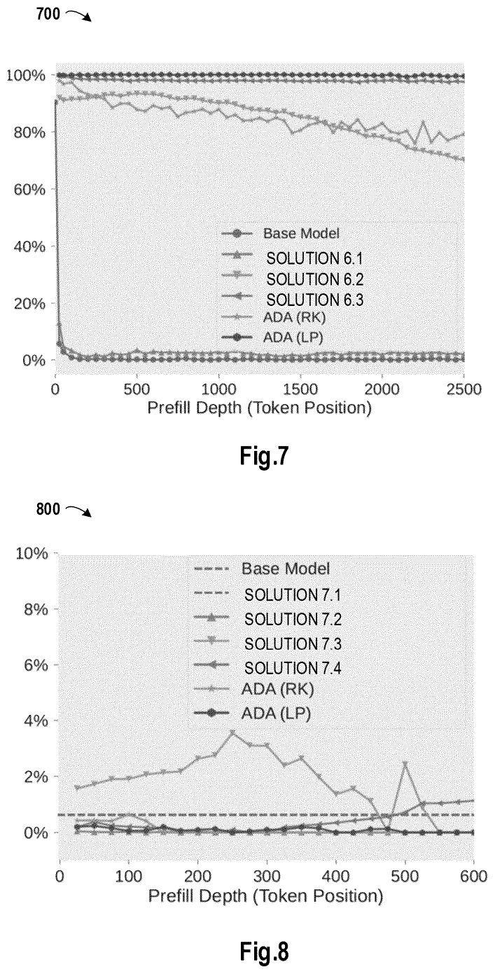

FIG. 7 illustrates an example diagram 700 of average refusal rates against deep prefill attacks across a diverse set of models according to implementations of the present disclosure. FIG. 7 highlights a clear hierarchy of robustness against the deep prefill attacks. Specifically, experiments show that: (1) Existing alignment methods are not depth-robust. Across all tested families, the safety of the Base Models collapses almost immediately, with refusal rates dropping to near-zero. While Deep Alignment offers a minor improvement at shallow depths, its effectiveness steadily decays as the prefill length increases (e.g., dropping to 40% refusal at a 500-token prefill). (2) ADA (RK) is already highly effective. Its performance correlates with the base model's alignment, achieving over 95% refusal across all depths on well-aligned models like the Llama series and is consistently comparable with the Self-Defense baseline, which requires an explicit reflection prompt. (3) ADA (LP) reveals a consistent, depth-independent safety awareness via safety tokens. The primary method, ADA (LP), achieves a near-perfect (100%) refusal rate that remains flat across all models and at all prefill depths up to 2,500 tokens. This confirms that probing the safety tokens provides a direct view into the model's true safety awareness, which remains robust and linearly separable at any depth. This underlying mechanism makes ADA (LP) fundamentally more reliable than any other approach, consistently outperforming even the strongest state-of-the-art guardrail models.

Further, over-refusal on benign tasks is also evaluated. FIG. 8 illustrates an example diagram 800 of over-refusal rates on standard benign datasets according to implementations of the present disclosure. FIG. 8 reveals that ADA is significantly more precise than the existing solutions. This demonstrates that its robust safety does not compromise utility on benign tasks.

The proposed method shows robustness under adversarial prompt attack. Here, the robustness is evaluated against two families of adversarial attacks. The first consists of white-box, optimization-based methods, which learns an adversarial suffix that maximizes the likelihood of an affirmative assistant response. The second family comprises paraphrasing attacks, which conceal harmful intent by rephrasing queries or embedding them in creative scenarios such as role-playing or storytelling. Defenses are evaluated on two benchmarks from available datasets. The attack results show that: the training-free variant, ADA (RK), already outperforms deep alignment; and ADA (LP) performs on par with existing guardrail models while consistently outperforming all other baselines. This superior performance stems from a key insight: adversarial attacks manipulate the prompt, but they do not change the fact that the resulting continuation is harmful. By probing the safety tokens, ADA (LP) analyzes the hidden states of this continuation, allowing it to reliably detect the underlying harmfulness and making it robust to prompt-based manipulations.

The proposed method provides robustness under supervised-fine tuning attacks. Different defenses are affected by continued Supervised Fine-Tuning (SFT). ADA (LP) method leverages a key architectural advantage during SFT. Because the safety check is an isolated forward pass, the present disclosure may temporarily disable the adapter during the probe. This shields the pre-trained linear probe from the distributional shift induced by the fine-tuning, preserving its original effectiveness. Performance remains strong even when the adapter is kept enabled.

Experiments show that ADA is uniquely resilient to SFT-based attacks. Benign SFT rapidly undoes Deep Alignment. A brief period of instruction tuning on the benign Alpaca dataset (as few as 50 steps with small learning rate) is enough to largely undo the safety training of Deep Alignment. This is likely due to conflicting objectives: standard instruction-following rewards smooth continuations, while deep alignment requires abrupt, midstream refusals. ADA is significantly more resilient to SFT. Both ADA (RK) and ADA (LP) maintain high refusal rates for far more SFT steps than any baseline. Even after 1,000 steps of Benign SFT, ADA (LP)'s refusal rate against a 100-token prefill remains above 99%. ADA (LP) is exceptionally robust to Adversarial SFT. Even when fine-tuned directly on harmful data, ADA (LP) retains a 90% refusal rate after 1,000 steps. Adversarial SFT may teach a model how to initiate a harmful response, but it does not alter the fundamental truth that the resulting content is still harmful. Because the probe analyzes the hidden state representations of this generated content, it remains effective at detecting this inherent harmfulness, even after the model has been fine-tuned maliciously. ADA-LP's robustness to adversarial prompts is unaffected by SFT. Even after the model undergoes adversarial fine-tuning, the Attack Success Rate against ADA (LP) remains at the same near-zero level as before the SFT.

Regarding practical application and check frequency, although experiments use a dense check frequency (every 25 tokens) to rigorously demonstrate that ADA's effectiveness is not sensitive to the specific generation depth, this rate may be adjusted in practice to balance safety and computational overhead. Increasing the check window to a more sparse 100 tokens still yields good performance, comparable to that of the best guardrail models. This less frequent checking remains highly effective against adversarial prompt attacks while maintaining a near-zero over-refusal rate on benign datasets, demonstrating that ADA (LP) is a flexible and practical solution for real-world deployment.

Regarding the choice of readout position for ADA (LP), the strong, linearly separable signal the present disclosure identify in the safety tokens is not a fragile property limited to a single, specific readout location; it is a robust phenomenon detectable at multiple points within a transformer block. To demonstrate this, an ablation study is conducted, where the hidden states of injected safety tokens are determined at six different readout positions across all layers. The results confirm that a high degree of linear separability is consistently found across a wide range of middle layers and, crucially, across all tested hook positions. While the signal is slightly more stable at the Input LayerNorm, even the submodule outputs yield high probe accuracy. This robustness to the choice of both the layer and the specific hook position underscores the strength of the underlying safety signal.

Regarding the inference cost, ADA (LP) offers a significant efficiency advantage in real deployment settings where a base model is hosted on the server and streams responses to users. In such cases, harmful content must be flagged and blocked during generation. A traditional guardrail model leads to unacceptable latency and memory usage, and makes real-time safety checks infeasible. In contrast, ADA (LP) reuses the base model's KV cache by forking directly into the check. As a result, the operation is as fast as generating a single next token, with constant latency of only 25 ms and extra memory limited to the injected safety tokens (for example, 2-3 MB). This constant-time, lightweight design enables real-time safety detection during streaming. Unlike many closed-source systems, which only flag harmful content after a full response is generated—by which point an adversary has already exfiltrated the unsafe output—ADA (LP) may detect issues mid-generation and stop the response immediately. Together, these properties make ADA (LP) not only a robust, SOTA-level safety mechanism with constant overhead, but also a uniquely scalable solution for long-context applications where traditional guardrails are both prohibitively slow and memory-inefficient.

In the present disclosure, a highly efficient approach is proposed to increase the LM safety. Specifically, the safety token is re-injected in midstream to trigger the model to “rethink” and refuse a harmful continuation. Further, the present disclosure provides a lightweight linear probe that leverages the trigger signal and effectively unlocks a model's own innate alignment, providing robust safety at any depth. It achieves performance comparable to existing guardrail models while exhibiting a near-zero over-refusal rate and, most critically, maintaining a constant, extremely low inference latency by reusing the same KV-Cache with the base model. This efficiency makes the present disclosure suitable for real-time content filtering in streaming applications, where developers may flexibly define the safety check frequency.

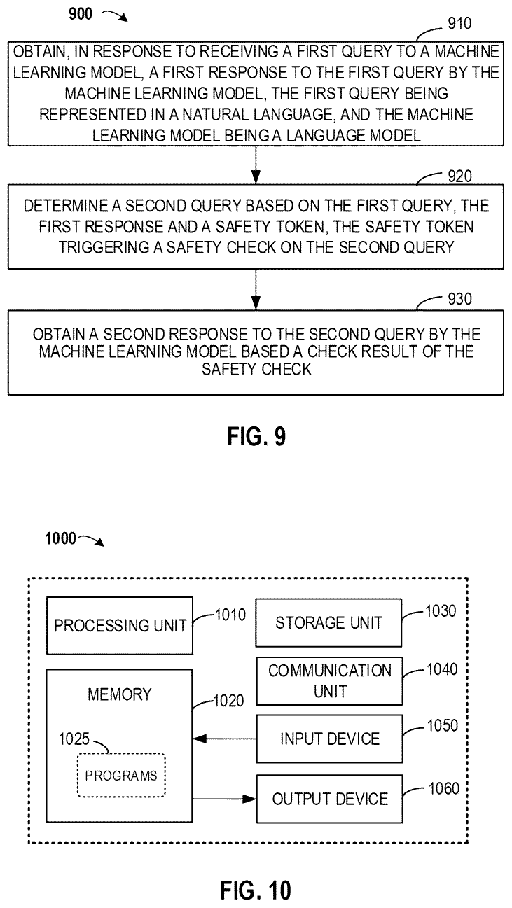

The above paragraphs have described details for the safety management. According to implementations of the present disclosure, a method is provided for safety management. Reference will be made to FIG. 9 for more details about the method, where FIG. 9 illustrates an example flowchart of a method 900 for safety management according to implementations of the present disclosure. At a block 910, in response to receiving a first query to a machine learning model, a first response to the first query is obtained by the machine learning model, the first query being represented in a natural language, and the machine learning model being a language model. At a block 920, a second query is determined based on the first query, the first response and a safety token, the safety token triggering a safety check on the second query. At a block 930, a second response to the second query is obtained by the machine learning model based a check result of the safety check.

In implementations of the present disclosure, obtaining the second response to the second query by the machine learning model based on the check result of the safety check comprises: in response to determining that the check result of the safety check indicates a safe result, obtaining the second response to the second query by the machine learning model.

In implementations of the present disclosure, obtaining the second response to the second query by the machine learning model based on the check result of the safety check comprises: in response to determining that a check result of the safety check indicates an unsafe result, stopping the first query; and providing a notification to indicate that the first query is stopped.

In implementations of the present disclosure, determining the second query based on the first query, the first response and the safety token comprises any of: determining the second query at a random time point; or determining the second query based on a depth of the first response.

In implementations of the present disclosure, the safety token comprises an assistant header that is determined by a tokenizer of the machine learning model, and the check result is determined by latent safety assessment of the machine learning model that is triggered by the assistant header.

In implementations of the present disclosure, the check result is determined by: obtaining a hidden state related to the second query in the machine learning model; and determining the check result by a linear classifier based on the hidden state.

In implementations of the present disclosure, obtaining the hidden state related to the second query in the machine learning model comprises: obtaining the hidden state from a network layer in a plurality of network layers of the machine learning model.

In implementations of the present disclosure, the network layer comprises a first normal layer in the plurality of network layers.

In implementations of the present disclosure, the linear classifier is obtained by: obtaining a plurality of reference samples related to the machine learning model, a reference sample in the plurality of reference samples comprising a reference hidden state related to a reference query and a reference label of the reference query, the reference label indicating whether the reference query is safe or not; and training the linear classifier with the plurality of reference samples.

In implementations of the present disclosure, the safety token comprises any of: an assistant header that is determined by a tokenizer of the machine learning model; or a portion of an assistant header that is determined by a tokenizer of the machine learning model.

According to implementations of the present disclosure, an apparatus is provided for safety management. The apparatus comprises: a first obtaining unit, configured to, in response to receiving a first query to a machine learning model, obtain a first response to the first query by the machine learning model, the first query being represented in a natural language, and the machine learning model being a language model; a determining unit, configured to determine a second query based on the first query, the first response and a safety token, the safety token triggering a safety check on the second query; and a second obtaining unit, configured to obtain a second response to the second query by the machine learning model based a check result of the safety check. Further, the apparatus may comprise other units for implementing other steps in the method 900.

According to implementations of the present disclosure, an electronic device is provided for implementing the method 900. The electronic device comprises: a computer processor coupled to a computer-readable memory unit, the memory unit comprising instructions that when executed by the computer processor implements a method for safety management. The method comprises: in response to receiving a first query to a machine learning model, obtaining a first response to the first query by the machine learning model, the first query being represented in a natural language, and the machine learning model being a language model; determining a second query based on the first query, the first response and a safety token, the safety token triggering a safety check on the second query; and obtaining a second response to the second query by the machine learning model based a check result of the safety check.

In implementations of the present disclosure, obtaining the second response to the second query by the machine learning model based on the check result of the safety check comprises: in response to determining that the check result of the safety check indicates a safe result, obtaining the second response to the second query by the machine learning model.

In implementations of the present disclosure, obtaining the second response to the second query by the machine learning model based on the check result of the safety check comprises: in response to determining that a check result of the safety check indicates an unsafe result, stopping the first query; and providing a notification to indicate that the first query is stopped.

In implementations of the present disclosure, determining the second query based on the first query, the first response and the safety token comprises any of: determining the second query at a random time point; or determining the second query based on a depth of the first response.

In implementations of the present disclosure, the safety token comprises an assistant header that is determined by a tokenizer of the machine learning model, and the check result is determined by latent safety assessment of the machine learning model that is triggered by the assistant header.

In implementations of the present disclosure, the check result is determined by: obtaining a hidden state related to the second query in the machine learning model; and determining the check result by a linear classifier based on the hidden state.

In implementations of the present disclosure, obtaining the hidden state related to the second query in the machine learning model comprises: obtaining the hidden state from a network layer in a plurality of network layers of the machine learning model.

In implementations of the present disclosure, the network layer comprises a first normal layer in the plurality of network layers.

In implementations of the present disclosure, the linear classifier is obtained by: obtaining a plurality of reference samples related to the machine learning model, a reference sample in the plurality of reference samples comprising a reference hidden state related to a reference query and a reference label of the reference query, the reference label indicating whether the reference query is safe or not; and training the linear classifier with the plurality of reference samples.

In implementations of the present disclosure, the safety token comprises any of: an assistant header that is determined by a tokenizer of the machine learning model; or a portion of an assistant header that is determined by a tokenizer of the machine learning model.

According to implementations of the present disclosure, a computer program product, the computer program product comprising a computer readable storage medium having program instructions embodied therewith, the program instructions executable by an electronic device to cause the electronic device to perform the method 900.

FIG. 10 illustrates a block diagram of a computing device 1000 in which various implementations of the present disclosure may be implemented. It would be appreciated that the computing device 1000 shown in FIG. 10 is merely for purpose of illustration, without suggesting any limitation to the functions and scopes of the present disclosure in any manner. The computing device 1000 may be used to implement the above method 1000 in implementations of the present disclosure. As shown in FIG. 10, the computing device 1000 may be a general-purpose computing device. The computing device 1000 may at least comprise one or more processors or processing units 1010, a memory 1020, a storage unit 1030, one or more communication units 1040, one or more input devices 1050, and one or more output devices 1060.

The processing unit 1010 may be a physical or virtual processor and may implement various processes based on programs stored in the memory 1020. In a multi-processor system, multiple processing units execute computer executable instructions in parallel so as to improve the parallel processing capability of the computing device 1000. The processing unit 1010 may also be referred to as a central processing unit (CPU), a microprocessor, a controller, or a microcontroller.

The computing device 1000 typically includes various computer storage medium. Such medium may be any medium accessible by the computing device 1000, including, but not limited to, volatile and non-volatile medium, or detachable and non-detachable medium. The memory 1020 may be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof.

The storage unit 1030 may be any detachable or non-detachable medium and may include a machine-readable medium such as a memory, flash memory drive, magnetic disk, or another other media, which may be used for storing information and/or data and may be accessed in the computing device 1000.

The computing device 1000 may further include additional detachable/non-detachable, volatile/non-volatile memory medium. Although not shown in FIG. 10, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1040 communicates with a further computing device via the communication medium. In addition, the functions of the components in the computing device 1000 may be implemented by a single computing cluster or multiple computing machines that may communicate via communication connections. Therefore, the computing device 1000 may operate in a networked environment using a logical connection with one or more other servers, networked personal computers (PCs) or further general network nodes.

The input device 1050 may be one or more of a variety of input devices, such as a mouse, keyboard, tracking ball, voice-input device, and the like. The output device 1060 may be one or more of a variety of output devices, such as a display, loudspeaker, printer, and the like. By means of the communication unit 1040, the computing device 1000 may further communicate with one or more external devices (not shown) such as the storage devices and display device, with one or more devices enabling the user to interact with the computing device 1000, or any devices (such as a network card, a modem, and the like) enabling the computing device 1000 to communicate with one or more other computing devices, if required. Such communication may be performed via input/output (I/O) interfaces (not shown).

In some implementations, instead of being integrated in a single device, some, or all components of the computing device 1000 may also be arranged in cloud computing architecture. In the cloud computing architecture, the components may be provided remotely and work together to implement the functionalities described in the present disclosure. In some implementations, cloud computing provides computing, software, data access and storage service, which will not require end users to be aware of the physical locations or configurations of the systems or hardware providing these services. In various implementations, the cloud computing provides the services via a wide area network (such as Internet) using suitable protocols. For example, a cloud computing provider provides applications over the wide area network, which may be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The functionalities described herein may be performed, at least in part, by one or more hardware logic components. For example, and without limitation, illustrative types of hardware logic components that may be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Program code for carrying out the methods of the subject matter described herein may be written in any combination of one or more programming languages. The program code may be provided to a processor or controller of a general-purpose computer, special purpose computer, or other programmable data processing apparatus such that the program code, when executed by the processor or controller, causes the functions/operations specified in the flowcharts and/or block diagrams to be implemented. The program code may be executed entirely or partly on a machine, executed as a stand-alone software package partly on the machine, partly on a remote machine, or entirely on the remote machine or server.

In the context of this disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may include but not limited to an electronic, magnetic, optical, electromagnetic, infrared, or semiconductor system, apparatus, or device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are illustrated in a particular order, this should not be understood as requiring that such operations are performed in the particular order shown or in sequential order, or that all illustrated operations are performed to achieve the desired results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular implementations. Certain features that are described in the context of separate implementations may also be implemented in combination in a single implementation. Rather, various features described in a single implementation may also be implemented in multiple implementations separately or in any suitable sub-combination.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

From the foregoing, it will be appreciated that specific implementations of the presently disclosed technology have been described herein for purposes of illustration, but that various modifications may be made without deviating from the scope of the disclosure. Accordingly, the presently disclosed technology is not limited except as by the appended claims.

Implementations of the subject matter and the functional operations described in the present disclosure may be implemented in various systems, digital electronic circuitry, or in computer software, firmware, or hardware, including the structures disclosed in this specification and their structural equivalents, or in combinations of one or more of them. Implementations of the subject matter described in this specification may be implemented as one or more computer program products, i.e., one or more modules of computer program instructions encoded on a tangible and non-transitory computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) may be written in any form of programming language, including compiled or interpreted languages, and it may be deployed in any form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media, and memory devices, including by way of example semiconductor memory devices, e.g., EPROM, EEPROM, and flash memory devices. The processor and the memory may be supplemented by, or incorporated in, special purpose logic circuitry.

It is intended that the specification, together with the drawings, be considered exemplary only, where exemplary means an example. As used herein, the use of “or” is intended to include “and/or”, unless the context clearly indicates otherwise.

While the present disclosure contains many specifics, these should not be construed as limitations on the scope of any disclosure or of what may be claimed, but rather as descriptions of features that may be specific to particular implementations of particular disclosures. Certain features that are described in the present disclosure in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are illustrated in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations. Only a few implementations and examples are described and other implementations, enhancements and variations may be made based on what is described and illustrated in the present disclosure.

1. A method for safety management, comprising:
obtaining, in response to receiving a first query to a machine learning model, a first response to the first query by the machine learning model, the first query being represented in a natural language, and the machine learning model being a language model;
determining a second query based on the first query, the first response and a safety token, the safety token triggering a safety check on the second query; and
obtaining a second response to the second query by the machine learning model based a check result of the safety check.

2. The method of claim 1, wherein obtaining the second response to the second query by the machine learning model based on the check result of the safety check comprises: in response to determining that the check result of the safety check indicates a safe result, obtaining the second response to the second query by the machine learning model.

3. The method of claim 1, wherein obtaining the second response to the second query by the machine learning model based on the check result of the safety check comprises:
in response to determining that a check result of the safety check indicates an unsafe result, stopping the first query; and
providing a notification to indicate that the first query is stopped.

4. The method of claim 1, wherein determining the second query based on the first query, the first response and the safety token comprises any of:
determining the second query at a random time point; or
determining the second query based on a depth of the first response.

5. The method of claim 1, wherein the safety token comprises an assistant header that is determined by a tokenizer of the machine learning model, and the check result is determined by latent safety assessment of the machine learning model that is triggered by the assistant header.

6. The method of claim 1, wherein the check result is determined by:
obtaining a hidden state related to the second query in the machine learning model; and
determining the check result by a linear classifier based on the hidden state.

7. The method of claim 6, wherein obtaining the hidden state related to the second query in the machine learning model comprises: obtaining the hidden state from a network layer in a plurality of network layers of the machine learning model.

8. The method of claim 7, wherein the network layer comprises a first normal layer in the plurality of network layers.

9. The method of claim 6, wherein the linear classifier is obtained by:
obtaining a plurality of reference samples related to the machine learning model, a reference sample in the plurality of reference samples comprising a reference hidden state related to a reference query and a reference label of the reference query, the reference label indicating whether the reference query is safe or not; and
training the linear classifier with the plurality of reference samples.

10. The method of claim 1, wherein the safety token comprises any of:
an assistant header that is determined by a tokenizer of the machine learning model; or
a portion of an assistant header that is determined by a tokenizer of the machine learning model.

11. An electronic device, comprising a computer processor coupled to a computer-readable memory unit, the memory unit comprising instructions that when executed by the computer processor implements a method for safety management, the method comprising:
obtaining, in response to receiving a first query to a machine learning model, a first response to the first query by the machine learning model, the first query being represented in a natural language, and the machine learning model being a language model;
determining a second query based on the first query, the first response and a safety token, the safety token triggering a safety check on the second query; and
obtaining a second response to the second query by the machine learning model based a check result of the safety check.

12. The device of claim 11, wherein obtaining the second response to the second query by the machine learning model based on the check result of the safety check comprises: in response to determining that the check result of the safety check indicates a safe result, obtaining the second response to the second query by the machine learning model.

13. The device of claim 11, wherein obtaining the second response to the second query by the machine learning model based on the check result of the safety check comprises:
in response to determining that a check result of the safety check indicates an unsafe result, stopping the first query; and
providing a notification to indicate that the first query is stopped.

14. The device of claim 11, wherein determining the second query based on the first query, the first response and the safety token comprises any of:
determining the second query at a random time point; or
determining the second query based on a depth of the first response.

15. The device of claim 11, wherein the safety token comprises an assistant header that is determined by a tokenizer of the machine learning model, and the check result is determined by latent safety assessment of the machine learning model that is triggered by the assistant header.

16. The device of claim 11, wherein the check result is determined by:
obtaining a hidden state related to the second query in the machine learning model; and
determining the check result by a linear classifier based on the hidden state.

17. The device of claim 16, wherein obtaining the hidden state related to the second query in the machine learning model comprises: obtaining the hidden state from a network layer in a plurality of network layers of the machine learning model.

18. The device of claim 16, wherein the linear classifier is obtained by:
obtaining a plurality of reference samples related to the machine learning model, a reference sample in the plurality of reference samples comprising a reference hidden state related to a reference query and a reference label of the reference query, the reference label indicating whether the reference query is safe or not; and
training the linear classifier with the plurality of reference samples.

19. The device of claim 11, wherein the safety token comprises any of:
an assistant header that is determined by a tokenizer of the machine learning model; or
a portion of an assistant header that is determined by a tokenizer of the machine learning model.

20. A non-transitory computer program product, the non-transitory computer program product comprising a computer readable storage medium having program instructions embodied therewith, the program instructions executable by an electronic device to cause the electronic device to perform a method for safety management, the method comprising:
obtaining, in response to receiving a first query to a machine learning model, a first response to the first query by the machine learning model, the first query being represented in a natural language, and the machine learning model being a language model;
determining a second query based on the first query, the first response and a safety token, the safety token triggering a safety check on the second query; and
obtaining a second response to the second query by the machine learning model based a check result of the safety check.
